(19) United States
(12) Patent Application Publication
(10) Pub. No.: US 2016/0340937 A1
(43) Pub. Date: Nov. 24, 2016

(54) DOOR LOCK DEVICE FOR VEHICLE

(71) Applicants: Tomohide NOBA, Kurokawa-gun (JP); Kouta OHARA, Kurokawa-gun (JP); Yoshinori HITOMI, Toyota-shi (JP)

(72) Inventors: Tomohide NOBA, Kurokawa-gun (JP); Kouta OHARA, Kurokawa-gun (JP); Yoshinori HITOMI, Toyota-shi (JP)

(73) Assignees: TOYOTA MOTOR EAST JAPAN, INC., Kurokawa-gun (JP); TOYOTA JIDOSHA KABUSHIKI KAISHA, Toyota-shi (JP)

(21) Appl. No.: 15/012,322

(22) Filed: Feb. 1, 2016

(30) Foreign Application Priority Data
May 22, 2015 (JP) 2015-104485

(51) Int. Cl. E05B 77/04; E05B 85/24; E05B 17/00; E05B 85/26; E05B 83/18

(52) U.S. Cl. CPC E05B 77/04; E05B 85/26; E05B 83/18; E05B 17/0045; E05B 85/243

(57) ABSTRACT

A striker is at a vehicle body. A door latch mechanism is at a back door and holds it in a closed state for the vehicle body by engaging the striker. The door latch mechanism has a latch, ratchet, latch base, latch shaft, ratchet shaft, latch spring and ratchet spring. The ratchet is formed by a latch locking part which locks the latch so that the latch holds the engagement state with the striker and at a position which waits ingress of the striker in a state that the striker does not engage the latch and a wall surface contact part which behaves as a rotation stopper of the ratchet by contacting to a wall surface of the latch base. The latch locking part and the wall surface contact part are provided so that positions of a center of rotation and a center of gravity of this ratchet correspond practically.

### TECHNICAL FIELD

This invention relates to a door lock device for vehicle which has a striker which is provided at a vehicle body side and which has a latch mechanism which is provided at a door side and engages to the striker. Particularly, this invention relates to the door lock device for vehicle which holds the door in a closed state by engaging the latch mechanism to the striker.

### BACKGROUND ART

Conventionally, the door lock device which has the striker which is provided at the vehicle body side and the door latch mechanism which is provided at the door side and engages to the striker, and which holds the door in the closed state by engaging the door latch mechanism to the striker is known.

As such the door lock device, these applicants develop the door lock device for vehicle which is applied to a flip-up type back door which is used in station wagons or in automobiles of hatch back type. The flip-up type back door opens and closes a back door opening which is formed at a vehicle rear, and an upper end of this back door is attached rotatably by a door hinge at a rear roof header part which is an upper edge side of the back door opening.

As shown in FIG. 7, this door lock device for vehicle has the striker 3 which is provided at a lower back panel 21 which is a lower edge side of the back door opening 2 and has the door latch mechanism 5 which is provided at a lower end of the back door 4 and holds the back door 4 in the closed state for the vehicle body 1 by engaging to the striker 3.

Concerning this door lock device for vehicle 100, in the case that the striker 3 does not engage to the door latch mechanism 5, because a latch locking part 52a of a ratchet 52 engages to second ratchet engaging step part 51c of a latch 51, the latch 51 can be locked in a position which waits ingress of the striker 3. Besides, in the case that the striker 3 engages to the door latch mechanism 5 in the full latch position, because the latch locking part 52a of the ratchet 52 engages to first ratchet engaging step part 51b of the latch 51, the latch 51 can be locked so as to hold an engagement state with the striker 3. Here, in this specification, “full latch position” means a binding state of the latch which holds the position that the back door closes completely. Besides, in this specification, “locking” means to fasten by engaging. Incidentally, when the striker 3 engages to the door latch mechanism 5, a rubber 58 is fixed to a latch base so that a rotation stopping part 52b of the ratchet 52 does not rotate needlessly.

Besides, this door lock device for vehicle 100 satisfies collision performance requirements of the door latch which is regulated in Regulation No. 11 with regard to door latches and door retention components (hereinafter called “Regulation No. 11” in this specification) which is cited as technical requirements in notices which regulates details of safety standards for road trucking vehicles. That is, this collision test by an actual vehicle crashes a moving barrier to a rear surface, a front surface and each side surface of the vehicle body individually, and performs the test that the door latch mechanism is not unlocked from the full latch position in the state that a lock mechanism is unlocked.

There are no prior arts which should be described concerning such the door lock device for vehicle 100. This is because the prior arts that applicants know are not related to the inventions of the public known documents.

Besides, as the door lock device, the door lock device which has the latch mechanism and the lock mechanism is disclosed (for example, refer to Patent document No. 1).

The latch mechanism has an meshing groove which houses the striker, and also has the latch which has a hook part and a locking part, and the ratchet which has the hook part of the latch and an engagement part which engages to the locking part, and when the striker enters to the meshing groove of the latch, because the latch rotates depending on that ingress amount, the latch mechanism is composed so that the engagement part of the ratchet engages to the locking part of the latch, the meshing groove and the hook part in sequence.

The lock mechanism has a switching mechanism for switching to an unlocked state which transmits rotating operation of an open lever by door opening operation of an outside handle to the latch mechanism and to a locked state which does not transmit the rotating operation of the open lever by the door opening operation of the outside handle to the latch mechanism. Further, the lock mechanism has a transmitting mechanism which can transmit the rotating operation of the open lever by the door opening operation of the outside handle to the ratchet.

Besides, as the door lock device, a latch device for vehicle which can reduce contact sound of the inside of the device over long period is disclosed (for example, refer to Patent document No. 2). This latch device for vehicle has the latch which engages and holds the striker and the ratchet which holds the engagement state of the striker and the latch by meshing with the latch, and a supporting member which is provided at a side of a meshing surface of the ratchet is covered by resin material and also a buffering part whose gap is infilled by resin material is provided.

### PRIOR ART DOCUMENT

### Patent Document

Patent document No. 1: Japanese Patent Publication Number 2008-45293

Patent document No. 2: Japanese Patent Publication Number 2013-217148

### SUMMARY OF THE INVENTION

### Problem to be Solved by the Invention

However, in the door lock device for vehicle 100 which is provided at the abovementioned flip-up type back door, there was a room for improvement to maintain the closed state of the back door from a point of view of protection performance improvement of drivers. That is, as shown in FIG. 8 (A), FIG. 8 (B) and FIG. 8 (c), there was fear that the ratchet 52 malfunctions by collision energy when the moving barrier collides to the rear surface of the vehicle body.

Incidentally, FIG. 8 (A), FIG. 8 (B) and FIG. 8 (c) shows malfunction states of the ratchet 52 time-serially, (A) is a view before the collision of the moving barrier; (B) is a view of beginning of the collision of the moving barrier; and (C) is a view after the collision of the moving barrier. Besides, in FIG. 8 (A), FIG. 8 (B) and FIG. 8 (c), a dashed-dotted line L10 shows a back end position of the door latch mechanism 5.

A result of this rear surface collision test is explained concretely. In FIG. 8 (A), in the state that the striker 3 fits into a striker fitting groove 51a of the latch 51, because the latch locking part 52a of the ratchet 52 engages to the first ratchet engaging step part 51b of the latch 51, this latch is locked, and also because a latch spring 56 adds elastic restoring force counterclockwise and a ratchet spring 57 adds the elastic restoring force clockwise, the latch 51 holds the engagement state with the striker 3. That is, the door latch mechanism 5 is a locked state.

In such the door latch mechanism 5 of the locked state, as shown in FIG. 8 (B), when the moving barrier collides to the rear surface of the vehicle body, concerning the ratchet 52, in the state of FIG. 8 (A), because a position of the center of gravity BC shifts to the latch locking part side for a position of the center of rotation RC, the inertia moment which is caused by the collision energy of the inertia load of 1900 G becomes big than the elastic restoring force of the ratchet spring 57, and thereby the ratchet 52 rotates counterclockwise.

In the state that the door latch mechanism 5 is locked, when the ratchet 52 rotates counterclockwise, because the latch locking part 52a of the ratchet 52 disengages from the first ratchet engaging step part 51b of the latch 51, as shown in FIG. 8 (C), the latch 51 rotates counterclockwise by the elastic restoring force of the latch spring 56, and thereby the striker 3 disengages from the striker fitting groove 51a of the latch 51. Therefore, in the door latch mechanism 5, there was the room for improvement to maintain the closed state of the back door from the point of view of the protection performance improvement of drivers.

For such a disadvantage of the door lock device for vehicle 100, these applicants proposed an improved idea as shown in FIG. 9 (A). In this improved idea, a spacer 6 which comprises rigid foamed material is arranged at the rear end side of the vehicle in the lower back panel 21. This spacer 6 is provided in the inside of a rear bumper cover 7 in the state which extends to a vehicle width direction. Incidentally, the door lock device of vehicle 100 is the same as that which is described above. Besides, in FIG. 9 (A), a dashed-dotted line L11 shows a back end position of the door latch mechanism 5, and a dashed-dotted line L12 shows a back end position of the spacer 6.

When the moving barrier MB collides to the rear surface of the vehicle of the automobile that the spacer 6 is provided in the inside of this rear bumper cover 7, because the collision energy transmits to the lower back panel 21 through the spacer 6 which is provided in the inside of the rear bumper cover 7, the collision energy toward the front side of the vehicle is also added to the striker 3 which is provided at the lower back panel 21. Incidentally, in this time, as shown in FIG. 9 (B), before the ratchet 52 rotates counterclockwise by the collision energy, because the latch 51 and the ratchet 52 rotate in the direction which engage mutually by the striker 3 which starts the move to the front side of the vehicle, the door latch mechanism 5 can hold the closed state of the back door even if the collision energy is added by the moving barrier MB.

However, in this improved idea, because the spacer 6 needs to be provided in the inside of the rear bumper cover 7, in the current vehicles that weight saving in grams is the point for improvement of fuel efficiency or cost reduction, increase in vehicle weight or increase in cost according to it was not desirable.

Besides, because the abovementioned door lock device of the patent document No. 1 is the mechanism that the door can be opened by the door opening operation of the outside handle even if the lock mechanism of the locked state is destroyed, there was the room for improvement to maintain the closed state of the back door from the point of view of the protection performance improvement of drivers.

Besides, in the abovementioned latch device for vehicle of the patent document No. 2, even if the contact sound of the inside of the device can be reduced over long period, because the resin material which is provided as the buffering part at the ratchet becomes complicate shape, mold processing is performed by using mold for injection molding, and thereby there was a disadvantage that production cost increases.

This invention was carried out in order to solve these disadvantages. The objects of this invention are to provide the door lock device for vehicle that the collision performance requirements of the safety standards with respect to the door latch can be satisfied and also the closed state of the back door can be held even if the moving barrier collides with the bigger inertia load than the inertia load which is prescribed in this safety standards in the rear surface collision test.

Further, the object of this invention is to provide the door lock device for vehicle that the contact sound in the inside of the device can be reduced without increasing the production cost.

### Means for Solving the Problems

The door lock device for vehicle which is a first mode of this invention in order to accomplish the abovementioned objects has a striker which is provided at a vehicle body and a door latch mechanism which is provided at a door and holds the door in a closed state for the vehicle body by engaging to the striker.

The door latch mechanism has a latch which rotates by engaging to the striker, a ratchet which is arranged facing the latch and holds an engagement state of the striker and the latch by locking the latch which rotates, a latch base which incorporates the latch and the ratchet and is fixed to the door, a latch shaft which is fixed to the latch base and supports the latch rotatably, a ratchet shaft which is fixed to the latch base and supports the ratchet rotatably, a latch spring which biases the latch to a rotative direction which engages to the ratchet constantly and a ratchet spring which biases the ratchet to a direction which engages to the latch constantly. Incidentally, in this specification, “biasing” means increasing force.

The ratchet is formed by a latch locking part which locks the latch so that the latch holds the engagement state with the striker and also locks this latch at a position which waits ingress of the striker in a state that the striker does not engage to the latch and a wall surface contact part which behaves as a rotation stopper of the ratchet by contacting to a wall surface of the latch base, and the latch locking part and the wall surface contact part are provided so that positions of a center of rotation and a center of gravity of this ratchet correspond practically.

According to such the door lock device for vehicle which is the first mode, in a rear surface collision test, when a moving barrier collides with a bigger inertia load than the inertia load which is prescribed in safety standards, in the ratchet, because the latch locking part and the wall surface contact part are provided so that positions of a center of rotation and a center of gravity of this ratchet correspond practically, an inertia moment which is caused by collision energy of this inertia load becomes small than the elastic restoring force of the ratchet spring, and thereby the ratchet does not rotate so that the latch locking part disengages from the latch. Therefore, the door latch mechanism can be held the closed state of the back door even if the moving barrier collides.

In a second mode of this invention in the door lock device for vehicle which is the first mode, the ratchet is formed so that the wall surface contact part is folded in an U-shape along a direction of a shaft center of the ratchet shaft.

According to such the door lock device for vehicle which is the second mode, in the case that the position of the center of gravity of the ratchet shifts to a first locking part side and a second locking part side than the position of the center of rotation, when making the positions of the center of rotation and the center of gravity of the ratchet correspond practically by increasing the weight of the wall surface contact part, it can be accomplished without increasing an installation area of the latch base.

In a third mode of this invention in the door lock device for vehicle which is the second mode, a cushion rubber is sandwiched in a protruding state at an U-shape part of the wall surface contact part so as to contact to the wall surface of the latch base. Incidentally, in this specification, “sandwiching” means to be supported in a state which is sandwiched.

According to such the door lock device for vehicle which is the third mode, only by sandwiching the cushion rubber at the U-shape part of the wall surface contact part of the ratchet, contact sound which is generated by contact of the wall surface of the latch base and the wall surface contact part of the ratchet can be reduced.

### Effect of the Invention

According to the door lock device for vehicle of this invention, the collision performance requirements of the safety standards with respect to the door latch can be satisfied and also the closed state of the back door can be held even if the moving barrier collides with the bigger inertia load than the inertia load which is prescribed in this safety standards in the rear surface collision test.

Further, according to the door lock device for vehicle of this invention, the contact sound in the inside of the device can be reduced without increasing the production cost.

### BRIEF DESCRIPTION OF THE DRAWINGS

FIGS. 1 (A) and 1 (B) Views which show a preferred embodiment in the door lock device for vehicle of this invention.

FIG. 1 (A) A perspective view which shows the door latch mechanism.

FIG. 1 (B) A perspective view which shows a relation of the door latch mechanism and a lock mechanism.

FIGS. 2 (A)-2 (C) Views which show the ratchet of the door latch mechanism of FIG. 1 (A).

FIG. 2 (A) A perspective view showing from a rear surface in a state which disengages the ratchet shaft.

FIG. 2 (B) A perspective view showing from a surface.

FIG. 2 (C) An A-A sectional view of FIG. 2 (B).

FIGS. 3 (A) and 3 (B) Views which show other embodiment of the ratchet of this invention.

FIG. 3 (A) A perspective view showing from a surface.

FIG. 3 (B) A B-B sectional view of FIG. 3 (A).

FIG. 4 An explanatory view which shows an outline of the rear surface collision test.

FIGS. 5 (A)-5 (C) Side views which show states of the moving barrier and a rear part of the vehicle body in the rear surface collision test of FIG. 4.

FIG. 5 (A) A view before the collision of the moving barrier.

FIG. 5 (B) A view of beginning of the collision of the moving barrier.

FIG. 5 (C) A view after the collision of the moving barrier.

FIG. 6 (A) A top view which shows a stationary state of the door latch mechanism in a state of FIG. 5 (A).

FIG. 6 (B) A top view which shows an operating state of the door latch mechanism in a state of FIG. 5 (C).

FIG. 7 A perspective view which shows a mounting position in the rear surface of the vehicle body of the door lock device for vehicle.

FIGS. 8 (A)-8 (C) Top views which show a relation of the conventional door lock device for vehicle and the moving barrier.

FIG. 8 (A) A view before the collision of the moving barrier.

FIG. 8 (B) A view of beginning of the collision of the moving barrier.

FIG. 8 (C) A view after the collision of the moving barrier.

FIGS. 9 (A) and 9 (B) Views which show an improved idea for resolving a disadvantage of the conventional door lock device for vehicle.

FIG. 9 (A) A side view which shows a relation of the rear part of the vehicle body.

FIG. 9 (B) A top view after the collision of the moving barrier.

### MODE FOR CARRYING OUT THE INVENTION

Hereinafter, the embodiments for carrying out the door lock device for vehicle of this invention are explained by referring to the drawings. Incidentally, although directions are shown by arrows in each drawing which is used in the embodiments for carrying out this invention, this shows the direction showing from a driver who sits in a driver seat. UP of the arrow shows an upper direction of the vehicle, FR of the arrow shows a front direction of the vehicle and LH of the arrow shows a left direction of the vehicle respectively. Besides, in also each drawing which is used in the abovementioned prior art and problem to be solved by the invention, the arrows which show similar directions are used.

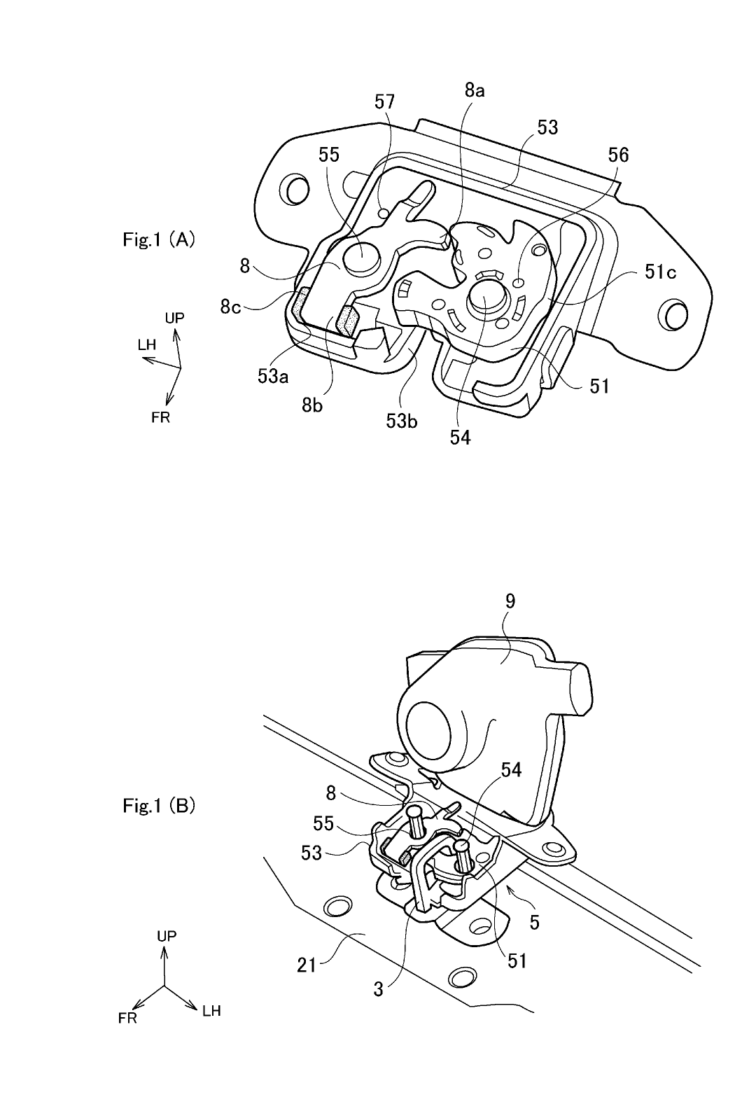

As shown in FIG. 1 (A) and FIG. 1 (B), the door lock device for vehicle of this invention has the latch 51 which rotates by engaging to the striker 3, the ratchet 8 which is arranged facing the latch 51 and holds the engagement state of the striker 3 and the latch 51 by locking the latch 51 which rotates, the latch base 53 which incorporates the latch 51 and the ratchet 8 and is fixed to the back door 4, the latch shaft 54 which is fixed to the latch base 53 and supports the latch 51 rotatably, the ratchet shaft 55 which is fixed to the latch base 53 and supports the ratchet 8 rotatably, the latch spring 56 which biases the latch 51 to the rotative direction which engages to the ratchet 8 constantly and the ratchet spring 57 which biases the ratchet 8 to the direction which engages to the latch 51 constantly. Incidentally, in each drawing of this specification, the latch spring 56 and the ratchet spring 57 show the positions for biasing.

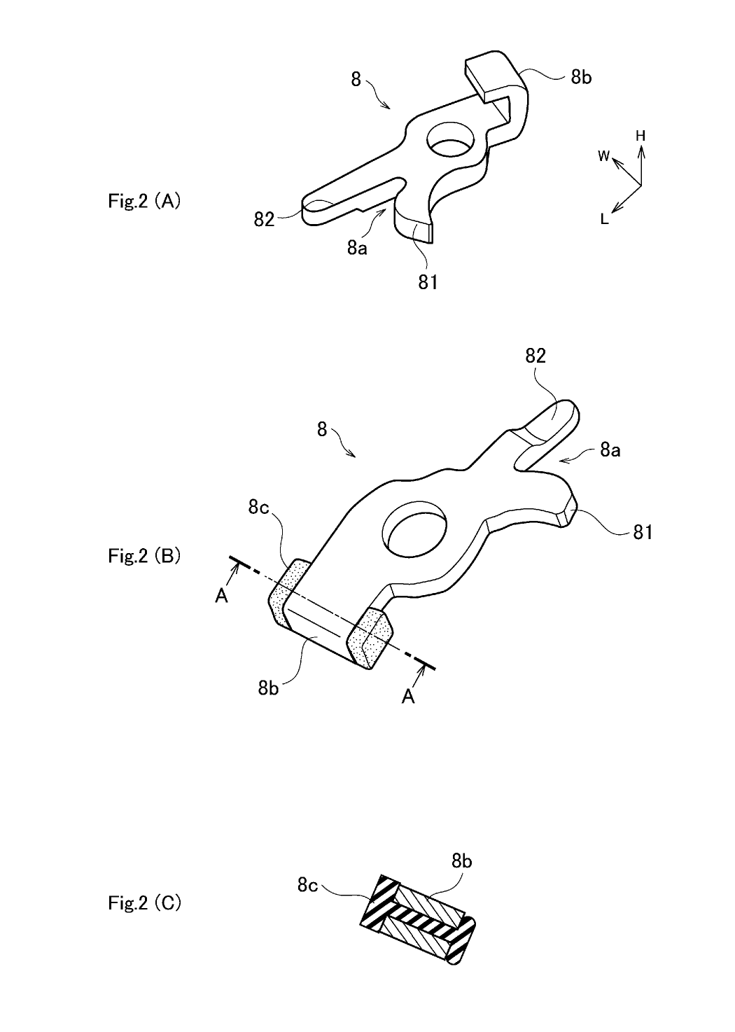

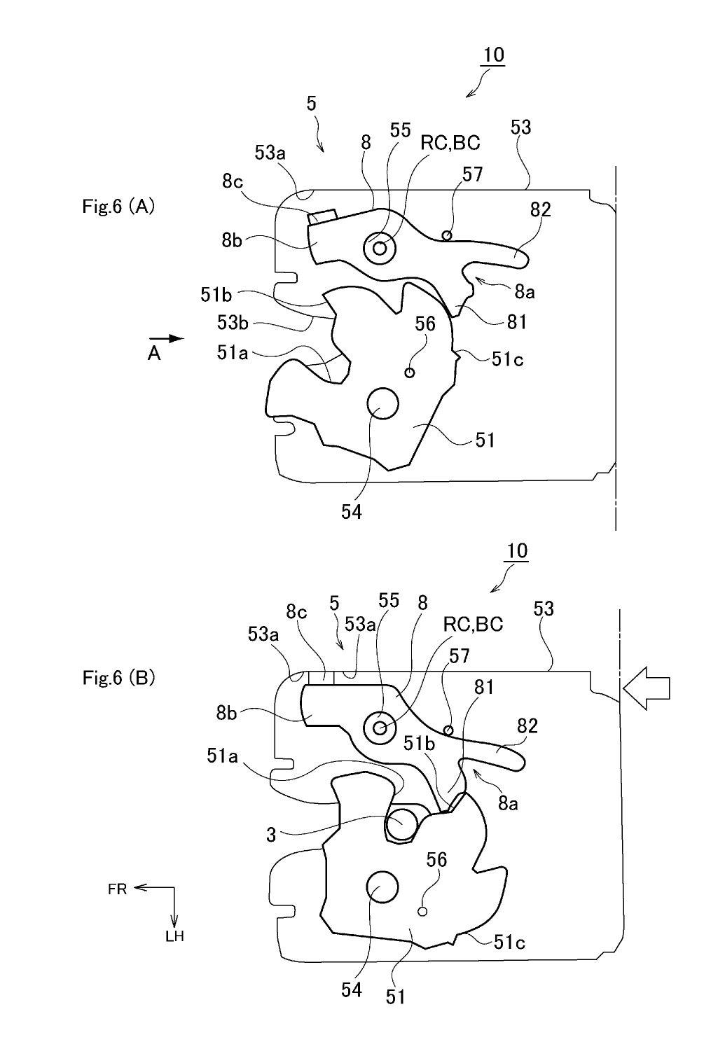

As shown in FIG. 2 (A), FIG. 2 (B), FIG. 6 (A) and FIG. 6 (B), the ratchet 8 locks the latch 51 so that the latch 51 holds the engagement state with the striker 3, and also the ratchet 8 is formed by the latch locking part 8a which locks this latch at the position which waits the ingress of the striker 3 in the state that the striker 3 does not engage to the latch 51 and the wall surface contact part 8b which behaves as the rotation stopper of the ratchet 8 by contacting to the wall surface 53a of the latch base 53, and the latch locking part 8a and the wall surface contact part 8b are provided so that the positions of the center of rotation RC and the center of gravity BC of this ratchet 8 correspond practically. Incidentally, although the latch locking part 8a is formed in a so-called fork shape which comprises two arms 81, 82, only one arm 81 which is positioned at the latch side functions as the latch locking part 8a.

The latch 51 has the striker fitting groove 51a for fitting the striker 3, the first ratchet engaging step part 51b which is provided at the striker fitting groove 51a and engages the latch locking part 8a of the ratchet 8 so that the latch 51 holds the engagement state with the striker 3 in the full latch position and the second ratchet engaging step part 51c which is provided at an outer peripheral surface of the latch 51 and engages this latch 51 to the latch locking part 8a of the ratchet 8 in the state that the striker 3 does not engage to the latch 51 at the position which waits the ingress of the striker 3.

Besides, in the latch base 53, a striker passing groove 53b for passing the striker 3 at the time of opening and closing of the back door 4 is formed.

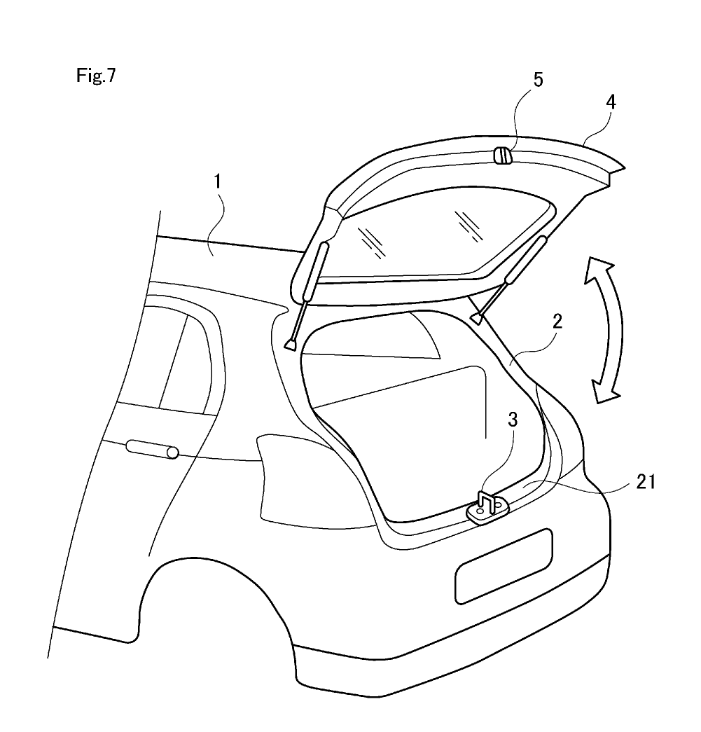

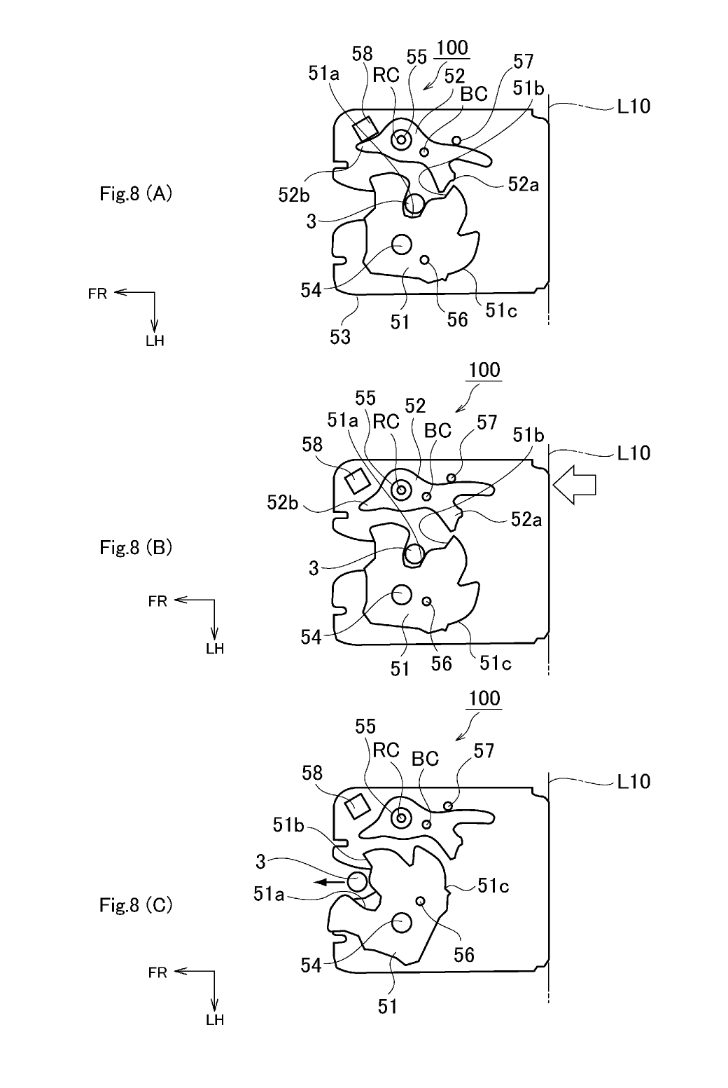

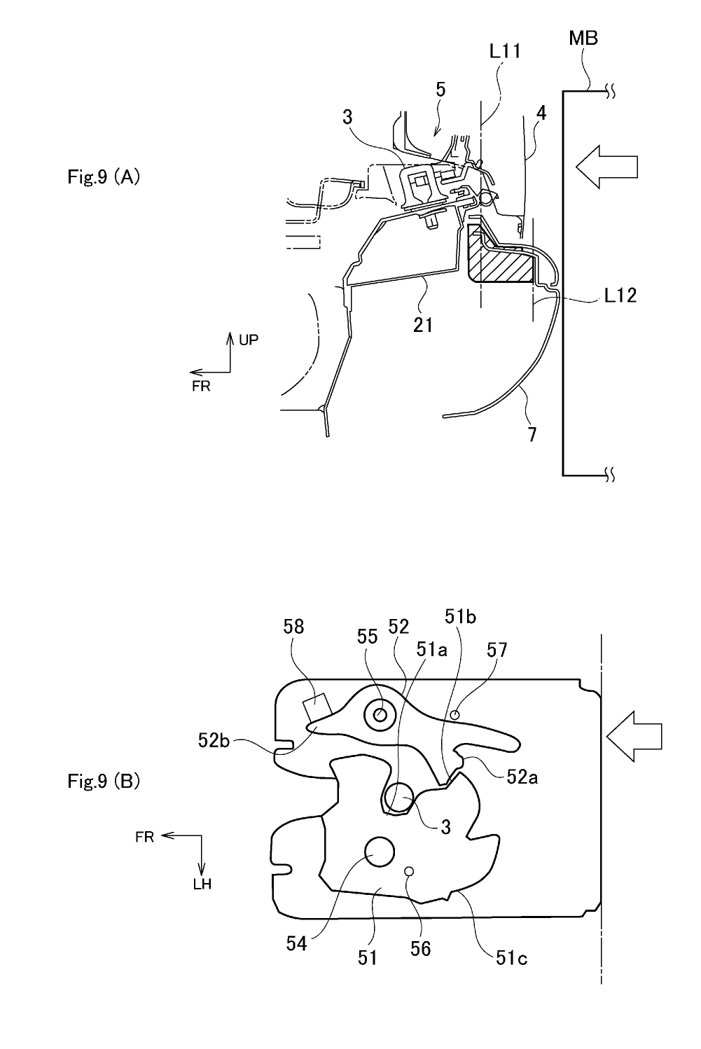

Incidentally, the door lock device for vehicle 10 of this invention is same as the conventional door lock device 100, as shown in FIG. 7, when the back door 4 is closed, because the door latch mechanism 5 engages to the striker 3, the back door 4 does not open unless handle operation (hereinafter called “door opening operation”) to open the back door 4 is performed by a door handle (not shown in drawing) which is provided at outside of the vehicle. Therefore, when the door opening operation is performed by the door handle, because the engagement state of the striker 3 is released by the door latch mechanism 5, the back door 4 can be opened.

Besides, in the door lock device for vehicle 10 of this invention, as shown in FIG. 1 (B), the lock mechanism 9 for switching to the unlocked state and the locked state by a door lock member (not shown in drawing) which is provided at outside of the vehicle or inside of the vehicle is provided. Therefore, when the back door 4 is locked in the closed state by the lock mechanism 9, the back door 4 does not open even if the door opening operation is performed by the door handle.

In the door lock device for vehicle 10 which is composed in this way, as well as the conventional door lock device for vehicle 100, in the case that the striker 3 does not engage to the door latch mechanism 5, because the latch locking part 8a (one arm 81) of the ratchet 8 engages to the second ratchet engaging step part 51c of the latch, the latch 51 can be locked at the position which waits the ingress of the striker 3 (refer to FIG. 6 (A)). Besides, in the case that the striker 3 engages to the door latch mechanism 5 in the full latch position, because the latch locking part 8a (one arm 81) of the ratchet 8 engages to the first ratchet engaging step part 51b of the latch 51, the latch 51 can be locked so as to hold the engagement state with the striker 3 (refer to FIG. 6 (B)).

Besides, as for the ratchet 8, the position of the center of gravity BC shifts to the locking part side for the position of the center of rotation RC in the conventional ratchet 52, and because the latch locking part 8a and the wall surface contact part 8b must be provided so that the positions of the center of rotation RC and the center of gravity BC of this ratchet 8 correspond practically for using the latch locking part 8a as it is, it is necessary to make the wall surface contact part 8b heavy. In this case, because enlarging the door latch mechanism 5 is undesirable from the point of view of downsizing of the mechanism, it is preferable to form the ratchet 8 so that the wall surface contact part 8b is folded in the U-shape along the direction of the shaft center of the ratchet shaft 55. That is, in the case that the position of the center of gravity BC of the ratchet 8 shifts to the latch locking part side than the position of the center of rotation RC, when making the positions of the center of rotation RC and the center of gravity BC of the ratchet 8 correspond practically by increasing the weight of the wall surface contact part 8b, it can be accomplished without increasing the installation area of the latch base 53.

Besides, when the striker 3 engages to the door latch mechanism 5 and the latch 51 rotates to the full latch position, the wall surface contact part 8b of the ratchet 8 contacts to the wall surface 53a of the latch base 53 so that this ratchet 8 does not rotate needlessly, and therefore, on this occasion, the contact sound is generated. For reducing this contact sound, as shown in FIG. 1 (A), FIG. 2 (A) and FIG. 2 (B), it is preferable to sandwich the cushion rubber 8c at the U-shape part of the wall surface contact part 8b in the protruding state so that it contacts to the wall surface 53a of the latch base 53. In this way, only by sandwiching the cushion rubber 8c at the U-shape part of the wall surface contact part 8b of the ratchet 8, the contact sound which is generated by the contact of the wall surface 53a of the latch base 53 and the wall surface contact part 8b of the ratchet 8 can be reduced.

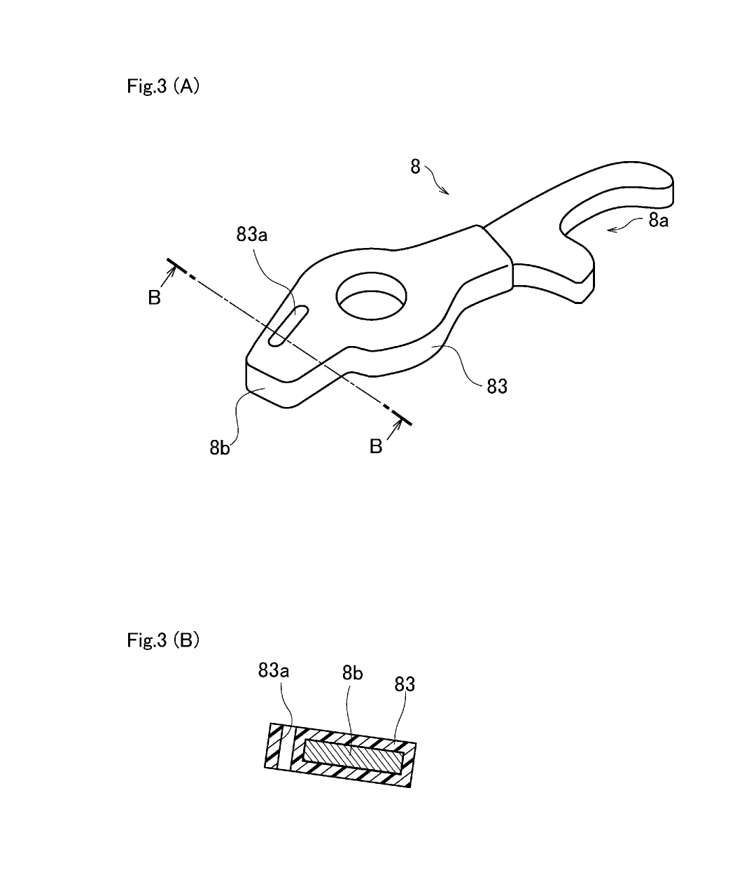

Incidentally, for reducing the contact sound of the door latch mechanism 5, as shown in FIG. 3 (A) and FIG. 3 (B), technology which coats the resin on the wall surface contact part 8b of the ratchet 8 is disclosed. In the ratchet 8 that reduction technique of this contact sound is used, when the wall surface contact part 8b of the ratchet 8 contacts to the wall surface 53a of the latch base 53a, a gap 83a as a cushion for mitigating impact is provided at a resin part 83. However, because the impact due to the contact is absorbed by bending a place of the resin part 83 that the gap 83a is provided, there is a disadvantage in durability. Besides, although this ratchet 8 is coated all with the resin excluding the latch locking part 8a, because the wall surface contact part 8b is folded in the U-shape and the gap 83a is provided in the resin part 83, a shape becomes complicate, and thereby the mold processing have to be performed by using the mold for the injection molding, and it becomes a factor for increasing the production cost. Therefore, in this invention, this reduction technique of the contact sound could not be adopted.

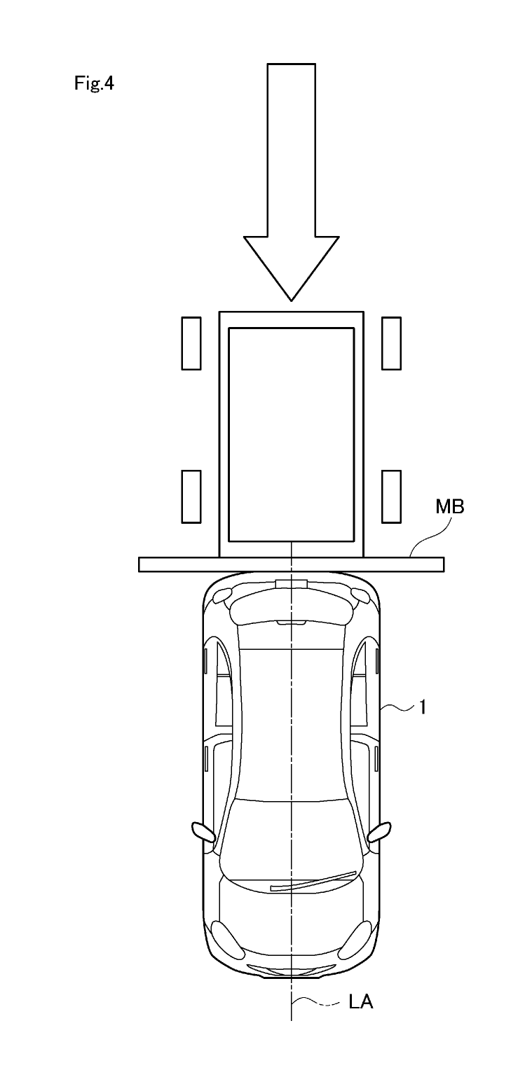

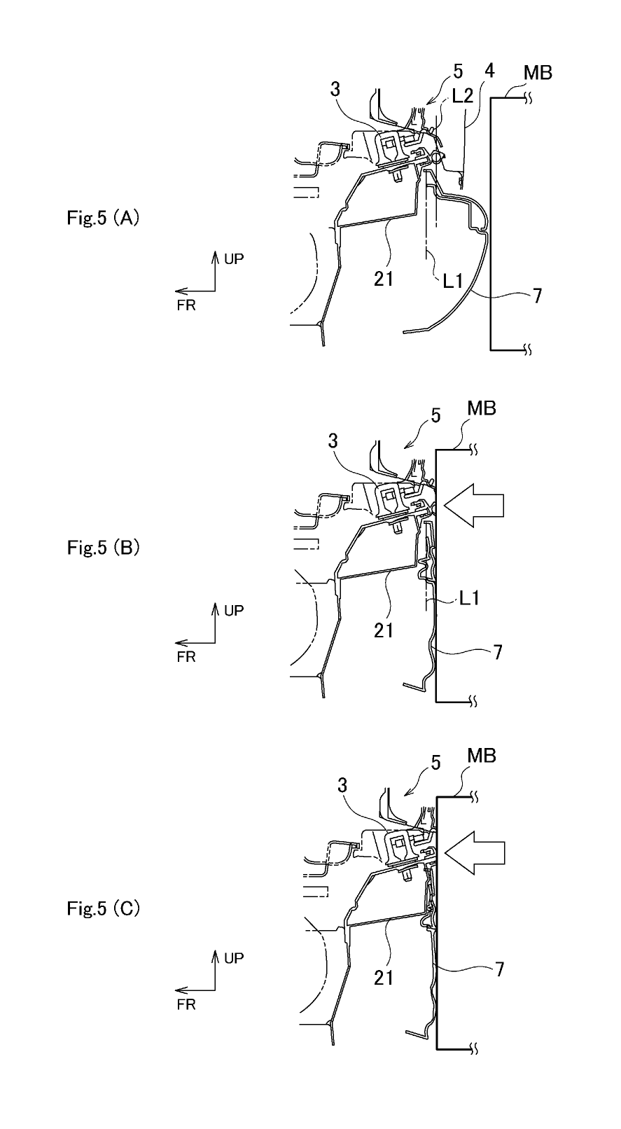

In the vehicle body 1 which has the door lock device for vehicle 10 of this invention which is composed in this way, the operation of the door latch mechanism 5 in the case that this test is performed by changing the inertia load of the rear surface collision test which is prescribed in Regulation No. 11 from the point of view of the protection performance improvement of drivers to 1900 G is explained by referring to FIG. 4, FIG. 5 (A), FIG. 5 (B), FIG. 5 (C), FIG. 6 (A) and FIG. 6 (B). Here, the automobile which is used in the test has the flip-up type back door.

Incidentally, FIG. 4 is a view which shows the rear surface collision test which makes the moving barrier MB collide from the rear surface of the vehicle body 1 so as to add the inertia load of 1900 G by the moving barrier MB for the door latch mechanism 5 in a parallel direction to a vertical axis LA of the vehicle body 1 in the state that the lock mechanism 9 is unlocked.

Besides, FIG. 5 (A), FIG. 5 (B) and FIG. 5 (C) shows the state that the moving barrier MB shifts time-serially for the rear surface of the vehicle body. That is, (A) is a view which shows the state of the rear bumper cover 7, the lower back panel 21 and the door latch mechanism 5 before the moving barrier MB collides, (B) is a view which shows the state of the rear bumper cover 7, the lower back panel 21 and the door latch mechanism 5 in the beginning that the moving barrier MB collides and (C) is a view which shows the state of the rear bumper cover 7, the lower back panel 21 and the door latch mechanism 5 after the moving barrier MB collides. Further, in FIG. 5 (A), although a dashed-dotted line L1 shows a position of back end of the lower back panel 21 and a dashed-dotted line L2 shows a position of back end of the door latch mechanism 5, the position of the back end of the door latch mechanism 5 becomes same position as the position of the front end of the moving barrier MB in FIG. 5 (B) and the position of the back end of the door latch mechanism 5 and the position of the back end of the lower back panel 21 become same positions as the position of the front end of the moving barrier MB in FIG. 5 (C), and therefore the descriptions of the dashed-dotted lines are omitted.

A door closing operation of the back door 4 that this door lock device for vehicle 10 is applied is as follows. When the back door 4 which is opened to upper direction is moved to lower direction so as to become the closed state, as shown in FIG. 6 (A), the striker 3 which is provided in the vehicle body 1 enters to the striker passing groove 53b from the direction of the arrow A, and fits into the striker fitting groove 51a which is formed in the latch 51. The latch 51 rotates clockwise around the latch shaft 54 while maintaining the engagement state with the striker 3, and reaches to the full latch position. In the striker 3, the latch locking part 8a (one arm 81) of the ratchet 8 engages to the first ratchet engaging step part 51b of the latch 51 finally, thereby a series of the door closing operation of the back door 4 is completed.

In this way, a result of the rear surface collision test by the vehicle body 1 whose back door 4 is the closed state is explained concretely. In FIG. 5 (A) and FIG. 6 (B), in the state that the striker 3 fits into the striker fitting groove 51a of the latch 51, because the latch locking part 8a (one arm 81) of the ratchet 8 engages to the first ratchet engaging step part 51b of the latch 51, and also because the latch spring 56 adds the elastic restoring force counterclockwise and the ratchet spring 57 adds the elastic restoring force clockwise, the latch 51 holds the engagement state with the striker 3. That is, the door latch mechanism 5 becomes the locked state.

In such the door lock device for vehicle 10 of the locked state, as shown in FIG. 5 (B) and FIG. 5 (C), when the moving barrier MB collides to the rear surface of the vehicle body, because that collision energy is transmitted to the door latch mechanism 5 and is subsequently transmitted to the lower back panel 21, the striker 3 which is provided in the lower back panel 21 does not go to the front side of the vehicle before the collision energy transmits to the door latch mechanism 5. Therefore, before the collision energy transmits to the door latch mechanism 5, the latch 51 and the ratchet 8 cannot rotate to the binding direction mutually by the striker 3.

However, in the ratchet 8, because the latch locking part 8a and the wall surface contact part 8b are provided so that the positions of the center of rotation RC and the center of gravity BC of this ratchet 8 correspond practically, the inertia moment which is caused by the collision energy of this inertia load becomes small than the elastic restoring force of the ratchet spring 57, and thereby the ratchet 8 does not rotate so that the latch locking part 8a disengages from the latch 51.

Incidentally, because the latch locking part 8a and the wall surface contact part 8b are provided so that the positions of the center of rotation RC and the center of gravity BC of this ratchet 8 correspond practically, the inertia moment which is caused by the collision energy of this inertia load becomes small, and when making an object rotate, this is because the inertia moment becomes big as the distance of the center of rotation and the center of gravity of the object becomes large.

Besides, as for corresponding practically, even if it does not correspond completely, in the rear surface collision test, it means that the door latch mechanism does not unlock even if the moving barrier collides with the bigger inertia load than the inertia load which is prescribed in the safety standards concerning door latches.

Therefore, in the door latch mechanism 5, because the ratchet 8 does not malfunction even if the collision energy is added by the moving barrier MB, in the rear surface collision test, the closed state of the back door can be held even if the moving barrier collides with the bigger inertia load than the inertia load which is prescribed in the safety standards concerning door latches, and thereby the protection performance of drivers can be improved.

Besides, in the door lock device for vehicle 10 of this invention, also for input of the collision energy in side surface collision test not only rear surface collision test, because the inertia moment becomes small and the rotation of the ratchet 8 can be prevented, the closed state of the back door can be held also for the input of the collision energy at the time of the side surface collision.

Incidentally, although the abovementioned embodiment is applied to the back door, not only this, in also side doors of swing doors, as described above, if the door lock device for vehicle which has the striker which is provided in the vehicle body and the door latch mechanism which holds the door in the closed state for the vehicle body by engaging to the striker which is provided in the side door is arranged, needless to say, similar working-effect is possessed.

Heretofore, the explanation was performed by the particular mode of embodiment shown in the drawing about this invention. However, this invention is not limited to the mode of embodiment shown in the drawing. And, needless to say, any composition which is known heretofore can be adopted insofar as the effect of this invention is achieved.

What is claimed is:

1. A door lock device for vehicle having a striker being provided at a vehicle body and a door latch mechanism being provided at a door and holding said door in a closed state for said vehicle body by engaging to said striker, comprising:
said door latch mechanism having
a latch rotating by engaging to said striker,
a ratchet being arranged facing said latch and holding an engagement state of said striker and said latch by locking said latch rotating,
a latch base incorporating said latch and said ratchet and being fixed to said door,
a latch shaft being fixed to said latch base and supporting said latch rotatably,
a ratchet shaft being fixed to said latch base and supporting said ratchet rotatably,
a latch spring biasing said latch to a rotative direction engaging to said ratchet constantly, and
a ratchet spring biasing said ratchet to a direction engaging to said latch constantly,
wherein,
said ratchet is formed by
a latch locking part which locks said latch so that said latch holds the engagement state with said striker and also locks this latch at a position which waits ingress of said striker in a state that said striker does not engage to said latch and
a wall surface contact part which behaves as a rotation stopper of said ratchet by contacting to a wall surface of said latch base, and
said latch locking part and said wall surface contact part are provided so that positions of a center of rotation and a center of gravity of this ratchet correspond practically.

2. The door lock device for vehicle according to claim 1, wherein,
said ratchet is formed so that said wall surface contact part is folded in an U-shape along a direction of a shaft center of said ratchet shaft.

3. The door lock device for vehicle according to claim 2, wherein,
a cushion rubber is sandwiched in a protruding state at an U-shape part of said wall surface contact part so as to contact to said wall surface of said latch base.

4. A door lock device for vehicle having a striker being provided at a vehicle body and a door latch mechanism being provided at a door and holding said door in a closed state for said vehicle body by engaging to said striker, comprising:
said door latch mechanism having
a latch rotating by engaging to said striker,
a ratchet being arranged facing said latch and holding an engagement state of said striker and said latch by locking said latch rotating,
a latch base incorporating said latch and said ratchet and being fixed to said door,
a latch shaft being fixed to said latch base and supporting said latch rotatably,
a ratchet shaft being fixed to said latch base and supporting said ratchet rotatably,
a latch spring biasing said latch to a rotative direction engaging to said ratchet constantly, and
a ratchet spring biasing said ratchet to a direction engaging to said latch constantly,
wherein,
said ratchet is formed by
a latch locking part which locks said latch so that said latch holds the engagement state with said striker and also locks this latch at a position which waits ingress of said striker in a state that said striker does not engage to said latch and
a wall surface contact part which behaves as a rotation stopper of said ratchet by contacting to a wall surface of said latch base,
said latch locking part and said wall surface contact part are provided so that positions of a center of rotation and a center of gravity of this ratchet correspond practically, and
said ratchet is formed so that said wall surface contact part is folded in an U-shape along a direction of a shaft center of said ratchet shaft.

5. A door lock device for vehicle having a striker being provided at a vehicle body and a door latch mechanism being provided at a door and holding said door in a closed state for said vehicle body by engaging to said striker, comprising:
said door latch mechanism having
a latch rotating by engaging to said striker,
a ratchet being arranged facing said latch and holding an engagement state of said striker and said latch by locking said latch rotating,
a latch base incorporating said latch and said ratchet and being fixed to said door,
a latch shaft being fixed to said latch base and supporting said latch rotatably,
a ratchet shaft being fixed to said latch base and supporting said ratchet rotatably,
a latch spring biasing said latch to a rotative direction engaging to said ratchet constantly, and
a ratchet spring biasing said ratchet to a direction engaging to said latch constantly,
wherein,
said ratchet is formed by
a latch locking part which locks said latch so that said latch holds the engagement state with said striker and also locks this latch at a position which waits ingress of said striker in a state that said striker does not engage to said latch and
a wall surface contact part which behaves as a rotation stopper of said ratchet by contacting to a wall surface of said latch base,
said latch locking part and said wall surface contact part are provided so that positions of a center of rotation and a center of gravity of this ratchet correspond practically,
said ratchet is formed so that said wall surface contact part is folded in an U-shape along a direction of a shaft center of said ratchet shaft, and
a cushion rubber is sandwiched in a protruding state at an U-shape part of said wall surface contact part so as to contact to said wall surface of said latch base.
